(19) United States
(12) Patent Application Publication
(10) Pub. No.: US 2026/0340841 A1
(43) Pub. Date: Oct. 29, 2026

(54) ESTIMATION PROGRAM, METHOD, AND APPARATUS

(71) Applicant: Fujitsu Limited, Kawasaki-shi (JP)

(72) Inventor: Fan YANG, Edogawa (JP)

(73) Assignee: Fujitsu Limited, Kawasaki-shi (JP)

(21) Appl. No.: 19/707,461

(22) Filed: Jun. 15, 2026

Related U.S. Application Data
(63) Continuation of application No. PCT/JP2024/001003, filed on Jan. 16, 2024.

(51) Int. Cl. G06T 7/246; G06T 7/292; G06T 7/73; G06T 17/05

(52) U.S. Cl. CPC G06T 7/246; G06T 7/292; G06T 7/73; G06T 17/05; G06T 2207/30241; G06T 2207/30244

(57) ABSTRACT

An estimation apparatus includes a processor that executes a procedure. The procedure includes: estimating a first trajectory of a moving object and relative positions and relative orientations of a plurality of cameras disposed in a predetermined space, based on a first image obtained by imaging the moving object moving in the space by each of the plurality of cameras; estimating a second trajectory of the moving object based on a second image obtained by imaging the space from a viewpoint of the moving object while the moving object moves in the space; and estimating a position and an orientation of each of the plurality of cameras with respect to the space, based on association between the first trajectory and the second trajectory, and the relative positions and the relative orientations.

### CROSS-REFERENCE TO RELATED APPLICATION

This application is a continuation application of International Application No. PCT/JP2024/001003, filed Jan. 16, 2024, the disclosure of which is incorporated herein by reference in its entirely.

### FIELD

The disclosed technology relates to an estimation program, an estimation method, and an estimation apparatus.

### BACKGROUND

Hitherto, there has been a system in which a plurality of cameras are disposed on a wall, a ceiling, or the like in an indoor space such as a retail store or an underground parking lot to perform traffic flow management, safety monitoring, behavioral guidance, or the like of a person, a vehicle, or the like in a space such as the indoor space based on images captured by the cameras. In order to accurately execute a task in such a system, it is necessary to accurately recognize a position of a target object such as a person or a vehicle in the space. To this end, it is necessary to appropriately grasp a position and a orientation of the camera with respect to the space.

As a technology related to setting of the system as described above, for example, an image processing system has been proposed in which a plurality of cameras are installed such that a field-of-view overlapping region in which visual fields of adjacent cameras overlap each other is formed, and internal parameters of the respective cameras are acquired. The system tracks a moving object, outputs a time and coordinates of the moving object, acquires trajectories of the moving object, and connects the trajectories of the moving object based on an image feature amount of the moving object. Then, the system calculates an external parameter related to an attachment state of the camera as a set value based on the acquired coordinates, and stores the internal parameter and the external parameter in association with each other.

In addition, for example, a technology has been proposed in which four points such as four corners of a room are dropped in a scene layout, then four points corresponding to fields of view of cameras are dropped, and camera calibration is performed by association between the dropped points.

### CITED LITERATURE

### Patent Literature

Patent Literature 1: Japanese Patent Application Laid-Open No. 2019-41261

### Non Patent Literature

Non Patent Literature 1: Pushpak Pujari, “Optimize the Use of Physical Spaces With People Heatmaps,” Feb. 14, 2023.

### SUMMARY

According to an aspect of the embodiments, a non-transitory recording medium storing a program that causes a computer to execute estimation processing comprising: estimating a first trajectory of a moving object and relative positions and relative orientations of a plurality of cameras disposed in a predetermined space, based on a first image obtained by imaging the moving object moving in the space by each of the plurality of cameras; estimating a second trajectory of the moving object based on a second image obtained by imaging the space from a viewpoint of the moving object while the moving object moves in the space; and estimating a position and an orientation of each of the plurality of cameras with respect to the space, based on association between the first trajectory and the second trajectory, and the relative positions and the relative orientations.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for describing a system example.

FIG. 2 is a diagram for describing a problem in estimation of a position and a orientation of a fixed camera.

FIG. 3 is a diagram for describing a problem in estimation of the position and the orientation of the fixed camera.

FIG. 4 is a schematic configuration diagram of an estimation system according to the present embodiment.

FIG. 5 is a functional block diagram of an estimation apparatus according to the present embodiment.

FIG. 6 is a diagram illustrating an example of trajectories of a key point extracted from a first image.

FIG. 7 is a diagram for describing grouping of the fixed cameras.

FIG. 8 is a diagram illustrating an example of grouping of fixed cameras.

FIG. 9 is a diagram for describing estimation of relative positions and relative orientations of the fixed cameras.

FIG. 10 is a diagram for describing estimation of a footprint of a real scale and three-dimensional point cloud information of a space.

FIG. 11 is a diagram for describing merging of points of the footprint.

FIG. 12 is a diagram for describing association between the footprint of an unknown scale and the footprint of the real scale.

FIG. 13 is a diagram for describing estimation of a position and a orientation of the fixed camera with respect to the space.

FIG. 14 is a diagram for describing estimation of a position and a orientation of a single fixed camera with respect to the space.

FIG. 15 is a diagram illustrating an example of a factor graph according to the related art.

FIG. 16 is a diagram illustrating an example of a factor graph according to the present embodiment.

FIG. 17 is a diagram illustrating an example of optimization of the footprint of the real scale using the factor graph.

FIG. 18 is a diagram for describing construction of a spatial three-dimensional map.

FIG. 19 is a block diagram illustrating a schematic configuration of a computer functioning as the estimation apparatus.

FIG. 20 is a flowchart illustrating an example of estimation processing according to the present embodiment.

FIG. 21 is a flowchart illustrating an example of first estimation processing.

FIG. 22 is a flowchart illustrating an example of second estimation processing.

FIG. 23 is a schematic diagram illustrating an example of an application result of the present embodiment.

FIG. 24 is a diagram for describing another example of the construction of the spatial three-dimensional map.

### DESCRIPTION OF EMBODIMENTS

Hereinafter, an example of an embodiment according to the disclosed technology will be described with reference to the drawings.

In the present embodiment, positions and orientations of a plurality of cameras disposed in a space with respect to the space are estimated. Here, the reason why it is necessary to accurately estimate the positions and the orientations of the plurality of cameras disposed in the space with respect to the space will be described.

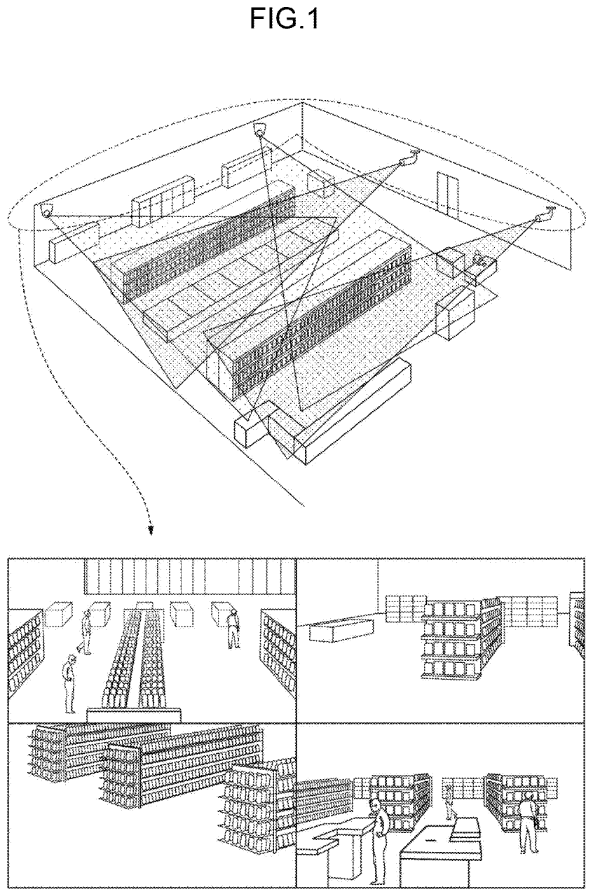

For example, as illustrated in FIG. 1, it is assumed that a plurality of fixed cameras are disposed on a wall, a ceiling, and the like in a space such as a retail store (a portion indicated by a broken line in FIG. 1), and tasks such as traffic flow management, safety monitoring, and behavioral guidance for a shopper in the space are performed. In order to accurately perform such tasks, it is necessary to accurately recognize a position of a person in the space. To this end, it is necessary to appropriately grasp a position and a orientation (six degrees of freedom) of the fixed camera with respect to the space. For example, in a case where only relative positions and relative orientations between the plurality of fixed cameras, which are not correlated with a layout of the space, can be grasped, it is not possible to accurately observe a situation in which the shopper enters or leaves the store through a door, a situation in which the shopper heads to a counter, a position in front of a specific shelf, or the like, a stay time of the shopper, or the like.

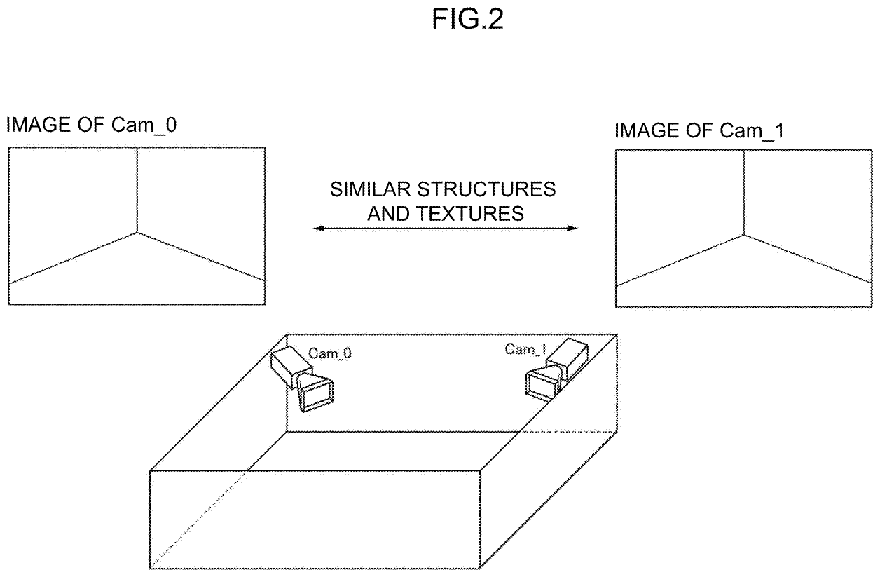

As a simple method of estimating the position and the orientation of each of the plurality of fixed cameras with respect to the space, it is conceivable to associate static key points in images captured by the respective fixed cameras. However, in such a method, for example, in a case where structures and textures are similar between images captured by a fixed camera Cam_0 and a fixed camera Cam_1 as illustrated in FIG. 2, there is a possibility that the position of the fixed camera is erroneously estimated.

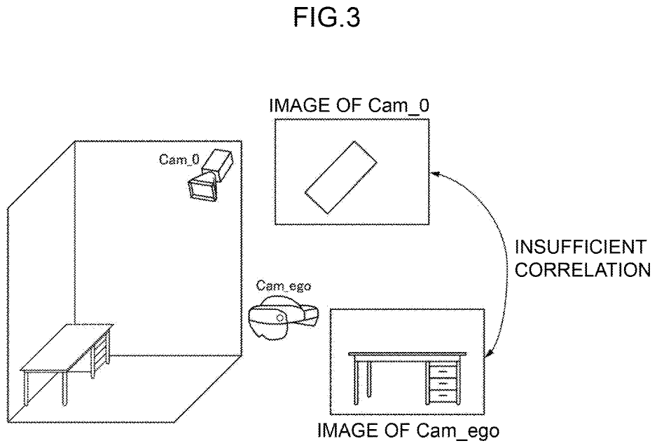

Furthermore, as another simple method of estimating the position and the orientation of each of the plurality of fixed cameras with respect to the space, a method of using an image captured by an egoistic camera (hereinafter, referred to as an “ego camera”) that captures the space from a viewpoint of a moving object moving in the space can be considered. In such a method, a static key point in the space is associated between an image captured by the fixed camera and an image captured by the ego camera. However, in such a method, for example, in a case where an appearance of the same static key point is greatly different between an image captured by a fixed camera Cam_0 and an image captured by an ego camera Cam_ego as illustrated in FIG. 3, it is difficult to accurately estimate a orientation of the fixed camera Cam_0.

In the present embodiment, as a method of estimating the position and the pose of each of the plurality of fixed cameras with respect to the space, a method robust to the visual ambiguity of a static key point as described above is proposed.

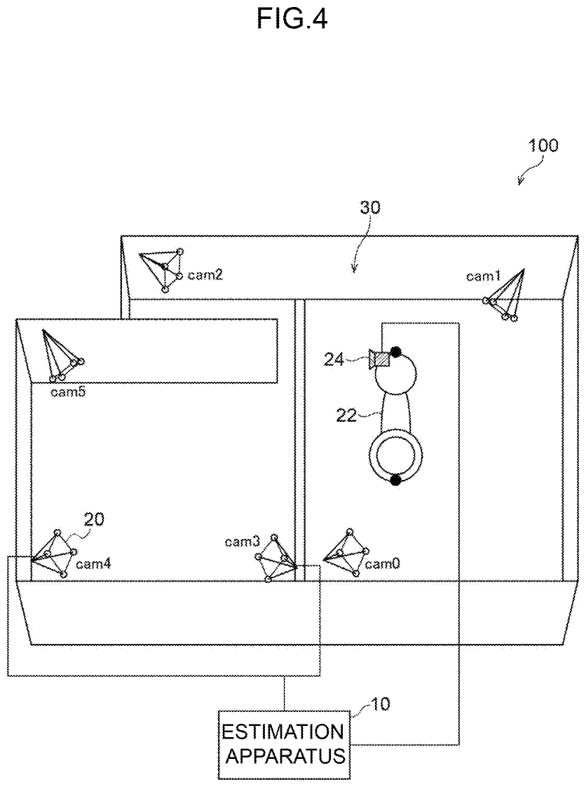

FIG. 4 illustrates a schematic configuration of an estimation system 100 according to the present embodiment. The estimation system 100 includes an estimation apparatus 10, a plurality of fixed cameras 20, a moving object 22, and an ego camera 24.

The fixed camera 20 is disposed in a predetermined space 30 such as a room. Specifically, each of the plurality of fixed cameras 20 is disposed on a wall, a ceiling, or the like of the space 30 such that imaging ranges of the plurality of fixed cameras 20 cover the entire space 30. In FIG. 4, each fixed camera 20 is represented by a quadrangular pyramid, an apex of the quadrangular pyramid represents a position of the fixed camera 20, and a quadrangle of a bottom surface of the quadrangular pyramid represents a viewing angle, that is, a orientation of the fixed camera 20. Furthermore, in FIG. 4, “cami (i=0, 1, 2, 3, 4, or 5 in the example of FIG. 4)” written alongside the quadrangular pyramid representing each fixed camera 20 is an identification number of each fixed camera 20. Hereinafter, the respective fixed cameras 20 will be referred to as “fixed camera 20” in a case where the fixed cameras 20 are described without distinction, and the fixed camera 20 with the identification number cami will be referred to as “fixed camera cami” in a case where the fixed cameras 20 are described with distinction.

Each of the fixed cameras 20 outputs an image obtained by imaging each imaging range for the space 30 to the estimation apparatus 10. In FIG. 4, a connection line between the fixed camera 20 and the estimation apparatus 10 is partially omitted. In the present embodiment, the fixed camera 20 outputs a first image obtained by capturing the moving object 22 moving in the space 30 to the estimation apparatus 10. The first image includes a plurality of frames, and each frame is associated with a timestamp indicating an imaging time.

The moving object 22 is a person, a self-propelled robot, or the like moving in the space 30. The moving object 22 moves so as to cover the entire space 30 while imaging the space 30 with the ego camera 24. In a case where the moving object 22 is a self-propelled robot, a movement route may be programmed so as to implement the movement as described above.

The ego camera 24 is a camera that images the space 30 from a viewpoint of the moving object 22. For example, in a case where the moving object 22 is a person, the ego camera 24 is worn on the chest, the head, or the like of the person. Furthermore, for example, in a case where the moving object 22 is a robot, the ego camera 24 is mounted on the robot. Specifically, the ego camera 24 is worn or mounted on the moving object 22 such that a vertical direction of the ego camera 24 coincides with a vertical direction of the moving object 22, and an imaging direction of the ego camera 24 coincides with a traveling direction of the moving object 22.

The ego camera 24 captures images necessary for self-position estimation of the moving object 22 and generation of an environment map around the moving object 22, such as a visible light image and a depth image, and outputs the captured images to the estimation apparatus 10. Hereinafter, the image captured by the ego camera 24 is referred to as a second image. The second image includes a plurality of frames, and each frame is associated with a timestamp indicating an imaging time.

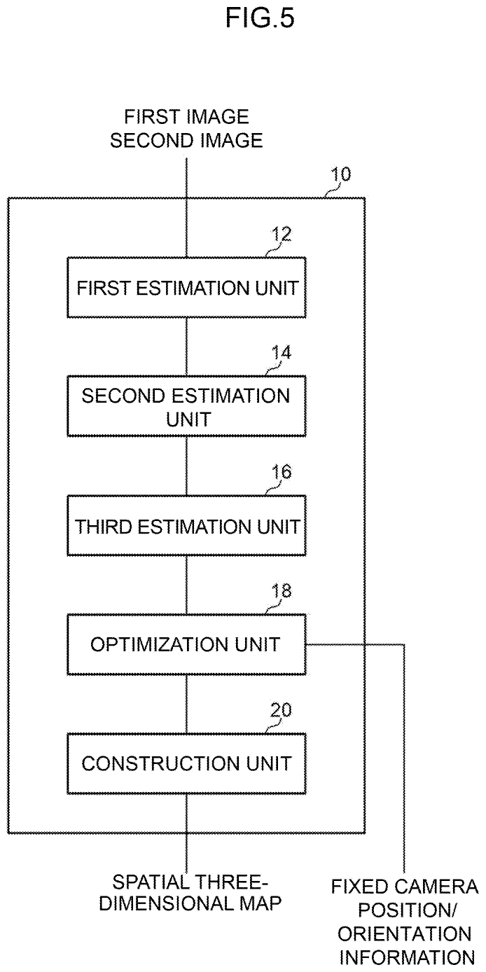

As illustrated in FIG. 5, the estimation apparatus 10 functionally includes a first estimation unit 12, a second estimation unit 14, a third estimation unit 16, an optimization unit 18, and a construction unit 20.

The first estimation unit 12 estimates, based on the first image input from each of the plurality of fixed cameras 20, a footprint (hereinafter, referred to as a “footprint of an unknown scale”) of the moving object 22 with an unknown scale and relative positions and relative orientations of the plurality of fixed cameras 20.

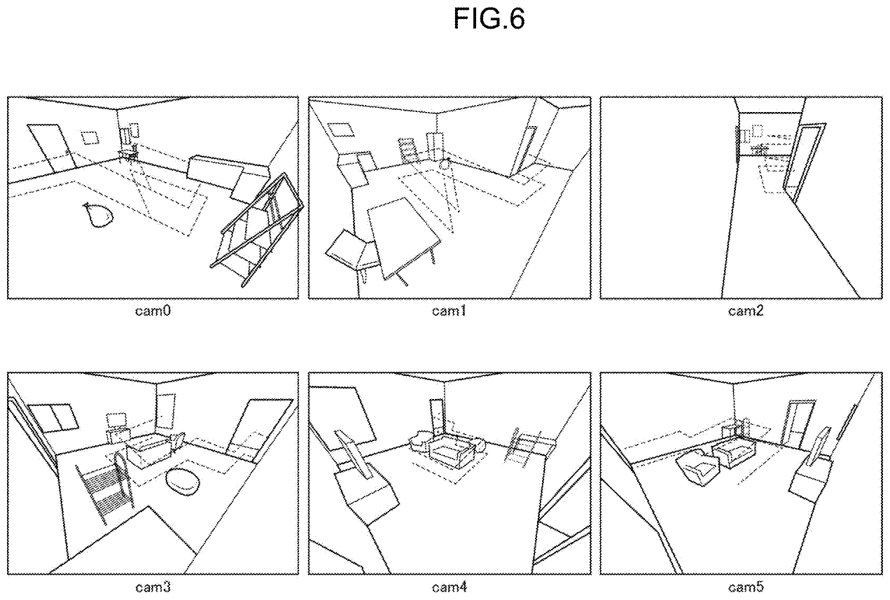

Specifically, the first estimation unit 12 detects a key point on the moving object 22 from each frame of the first image. For example, as illustrated in FIG. 4, a position of a top portion of the head and a foot position (black circles in FIG. 4) of the moving object 22 may be the key points. The first estimation unit 12 tracks the key point detected from each frame between the frames, and extracts a trajectory (broken line in FIG. 6) connecting the key points in the first image as illustrated in FIG. 6. The first estimation unit 12 may apply a filter to the trajectory connecting the key points to smooth the trajectory.

Here, as illustrated in FIG. 4, in a case where the space 30 is divided into a plurality of rooms, the imaging ranges covered by the respective fixed cameras 20 may respectively correspond to different rooms. In such a case, when the position and the orientation of each fixed camera 20 are estimated by association between the fixed cameras 20 that image different rooms, appropriate estimation cannot be performed.

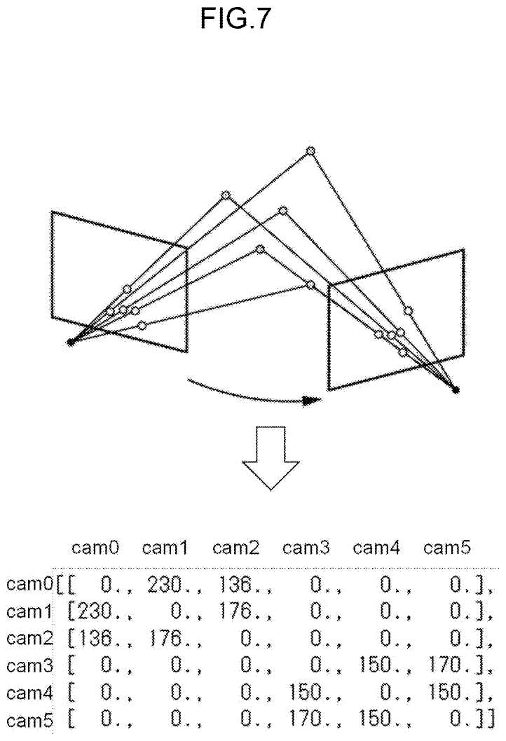

Therefore, the first estimation unit 12 groups the plurality of fixed cameras 20 based on the degree of overlap between the respective imaging ranges of the plurality of fixed cameras 20. Specifically, as illustrated on the upper side in FIG. 7, the first estimation unit 12 calculates, for each pair of two fixed cameras 20 among the plurality of fixed cameras 20, a frequency at which a common key point is detected as the key point of the moving object 22 detected from each frame of the first image. For example, as illustrated on the lower side in FIG. 7, the first estimation unit 12 prepares a matrix in which each fixed camera 20 is associated with each row and each column. The first estimation unit 12 counts the number of key points with the same timestamp, which are detected by both of the paired fixed cameras 20 corresponding to each element of the matrix. In the present embodiment, two key points are set on the moving object 22, and thus, a maximum value of the element of the matrix is the number of frames×2, and a minimum value thereof is 0. The value of the element of the matrix corresponds to the degree of overlap between the imaging ranges of the paired fixed cameras 20.

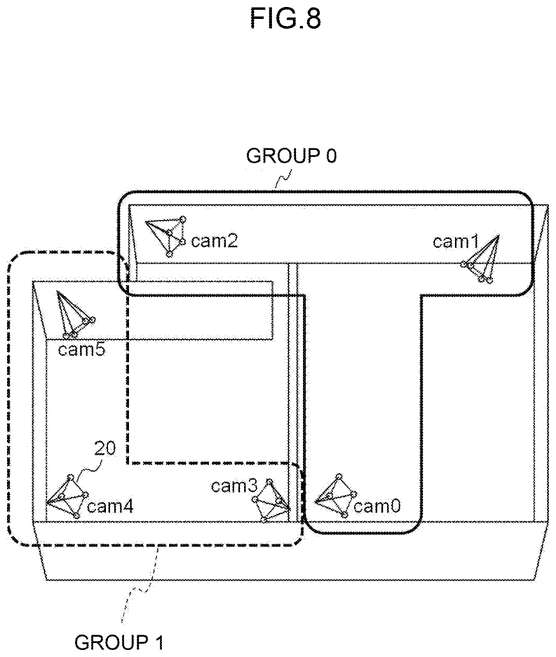

The first estimation unit 12 groups the plurality of fixed cameras 20 by clustering the respective elements of the matrix based on the values of the elements. For example, as illustrated in FIG. 8, a fixed camera cam0, a fixed camera cam1, and a fixed camera cam2 are classified as a group 0, and a fixed camera cam3, a fixed camera cam4, and a fixed camera cam5 are classified as a group 1.

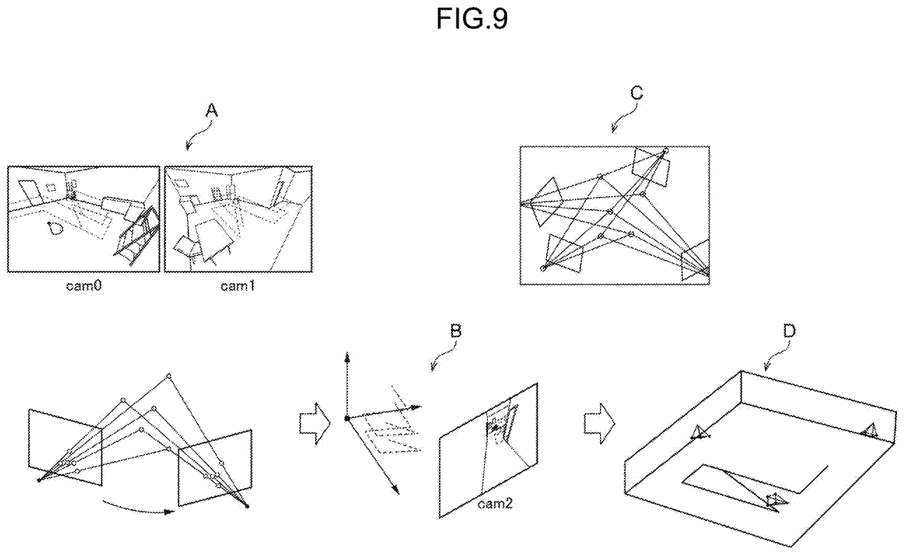

The first estimation unit 12 estimates the footprint of the unknown scale of the moving object 22 and the relative positions and the relative orientations of the plurality of fixed cameras 20 for each group. Specifically, as illustrated in A of FIG. 9, the first estimation unit 12 estimates the relative positions and the relative orientations of two fixed cameras 20 included in the group based on association between the key points for the two fixed cameras 20, and estimates the trajectory of the key point in three dimensions. For the estimation, for example, structure from motion (SfM) may be applied. Furthermore, as illustrated in B of FIG. 9, the first estimation unit 12 estimates the relative position and the relative orientation of another fixed camera 20 included in the group based on the first image captured by the another fixed camera 20 and the estimated three-dimensional trajectory. Furthermore, as illustrated in C of FIG. 9, the first estimation unit 12 performs bundle adjustment of the relative positions and the relative orientations of all the fixed cameras 20 included in the group.

In addition, as illustrated in D of FIG. 9, the first estimation unit 12 merges the three-dimensional trajectory based on the key point at the position of the top portion of the head with the three-dimensional trajectory based on the key point at the foot position to estimate the merged trajectory as the footprint. As a result, even in a case where the key point at the foot position of the moving object 22 is not detected on the first image due to blocking by an obstacle, it is possible to estimate the footprint in which an undetected portion is interpolated. The footprint is based on the relative positions and the relative orientations of the fixed cameras 20, and is a footprint of an unknown scale whose scaling ratio and rotation with respect to a footprint of a real scale are unknown. The footprint of the unknown scale is an example of a “first trajectory” according to the disclosed technology.

The second estimation unit 14 estimates the footprint of the real scale of the moving object 22 based on the second image input from the ego camera 24. The footprint of the real scale is an example of a “second trajectory” according to the disclosed technology.

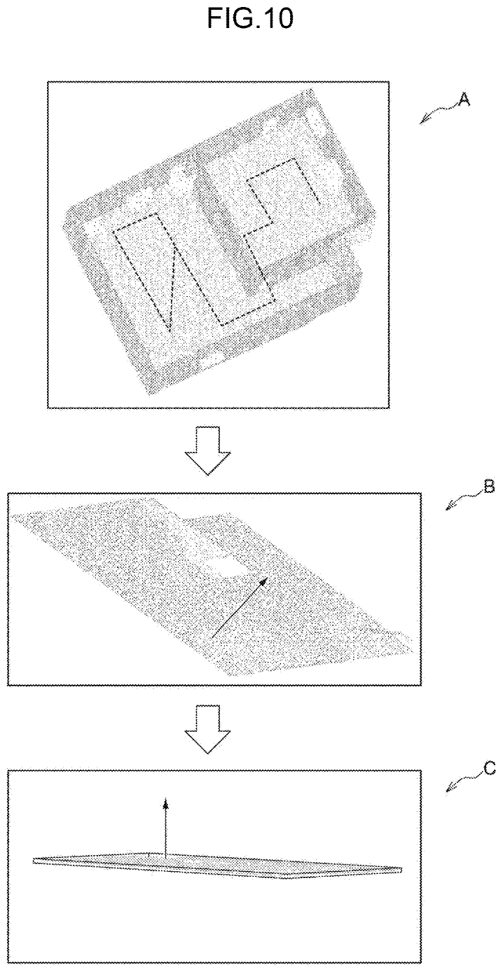

Specifically, the second estimation unit 14 simultaneously performs, based on the second image including the visible light image (RGB image) and the depth image, self-position estimation of the moving object 22 and generation of the environment map around the moving object 22 by applying simultaneous localization and mapping (SLAM), for example. As a result, as illustrated in A of FIG. 10, the second estimation unit 14 estimates the footprint of the real scale of the moving object 22 to which a result of the self-position estimation at each time is connected, and estimates three-dimensional point cloud information of the space 30.

Furthermore, as illustrated in B of FIG. 10, the second estimation unit 14 applies, for example, an existing segmentation method to extract a three-dimensional point cloud corresponding to a floor surface of the space 30 from the three-dimensional point cloud information of the space 30. Then, as illustrated in C of FIG. 10, the second estimation unit 14 converts coordinates of the three-dimensional point cloud information such that a normal vector of a plane indicated by the extracted three-dimensional point cloud is parallel to a vertical axis of a world coordinate system. In addition, the second estimation unit 14 also converts coordinates of the footprint of the real scale in accordance with the converted coordinates. As a result, it is possible to suppress a bias in association between the footprint of the real scale and the footprint of the unknown scale (which is described in detail below).

The third estimation unit 16 estimates the position and the orientation of each of the plurality of fixed cameras 20 with respect to the space 30 for each group based on the association between the footprint of the real scale and the footprint of the unknown scale and the relative positions and the relative orientations of the plurality of fixed cameras 20.

Specifically, the third estimation unit 16 merges points adjacent to each other in a spatiotemporal region for each footprint. As described above, the footprint of the unknown scale is a series of key points of the moving object 22 detected from the first image captured at each time, and the footprint of the real scale is a series of self-positions of the moving object at each time, the self-positions being estimated based on the second image. The key point at each time (timestamp T) of the footprint of the unknown scale and the self-position at each time (timestamp T) of the footprint of the real scale are each also referred to as a “point”.

More specifically, in a case where positions of the points corresponding to a plurality of consecutive timestamps are included within a predetermined range in the footprint of the real scale, the third estimation unit 16 merges the plurality of points by associating the plurality of points with one timestamp. Then, the third estimation unit 16 merges points in the footprint of the unknown scale, the points corresponding to the same timestamp as that of the merged point in the footprint of the real scale.

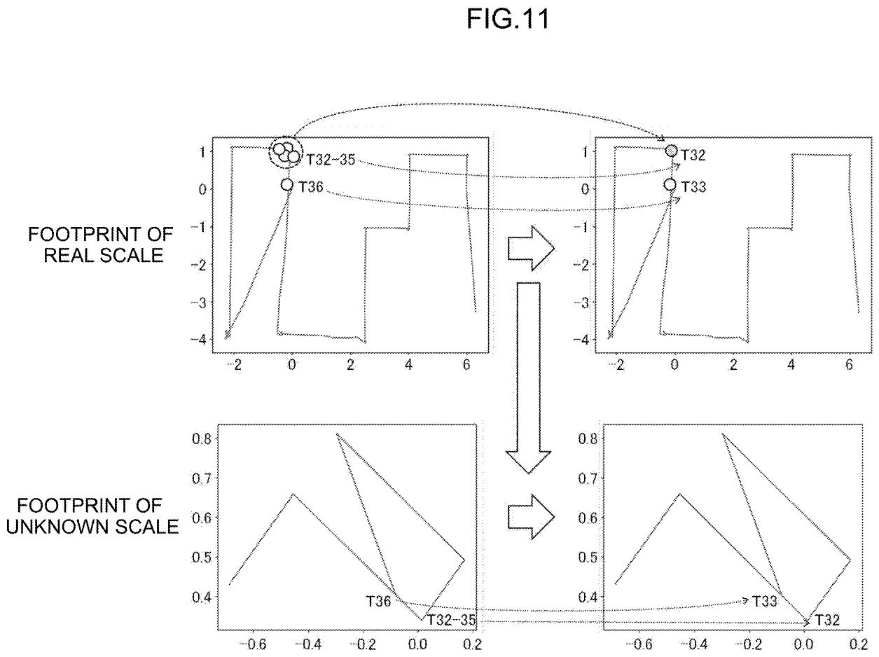

For example, the third estimation unit 16 detects points included in the same cluster as adjacent points by clustering the respective points of the footprint of the real scale based on a distance between the points. For example, as illustrated on the upper-left side in FIG. 11, points (white circles in FIG. 11) respectively corresponding to timestamps T32 to T35 of the footprint of the real scale are included in one cluster (a circle indicated by a broken line on the upper side in FIG. 11). In this case, as illustrated on the upper-right side in FIG. 11, for example, the third estimation unit 16 sets an average position of the points respectively corresponding to the timestamps T32 to T35 as a new point of the timestamp T32 (dotted circle in FIG. 11). The third estimation unit 16 associates points corresponding to a timestamp T36 and subsequent timestamps with points corresponding to the timestamp 33 and subsequent timestamps. Furthermore, as illustrated on the lower-left and lower-right sides in FIG. 11, the third estimation unit 16 merges the points corresponding to the timestamps T32 to T35 and adjusts the timestamps of the points corresponding to the timestamp T36 and the subsequent timestamps in the footprint of the unknown scale.

As described above, by merging points adjacent to each other in the spatiotemporal region for each footprint, it is possible to prevent the position from being excessively emphasized at the time of associating the footprints to be described later due to excessive concentration of the points at the same position.

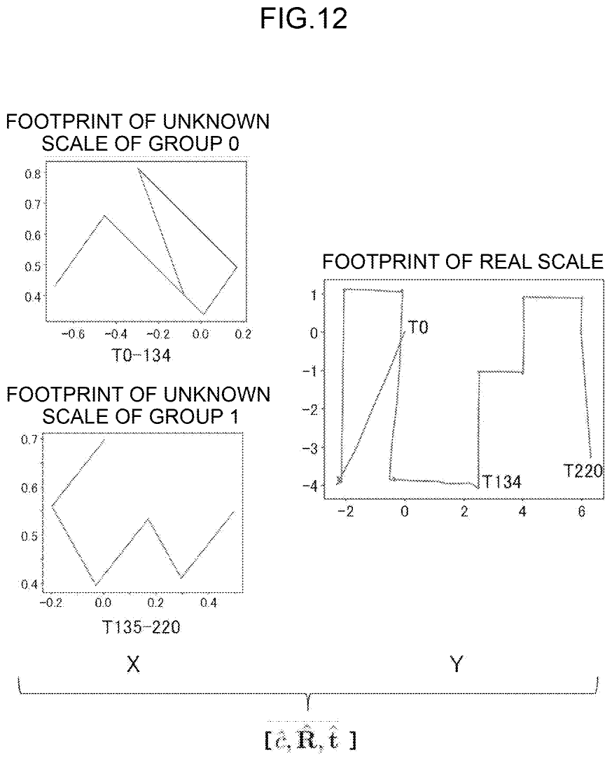

In addition, as illustrated in FIG. 12, the third estimation unit 16 associates each footprint of the unknown scale of each group after merging the points with the footprint of the real scale. Then, the third estimation unit 16 calculates parameters for converting the relative positions and the relative orientations of the fixed cameras 20 into the position and the orientation with respect to the space 30 based on the association. For example, the third estimation unit 16 calculates parameters [c\hat{ },R\hat{ },t\hat{ }] by the following Formula (1) using a point pattern matching algorithm (Reference Literature 1).
Reference Literature 1: Shinji UMEYAMA, “Point Pattern Matching Algorithm”, the transactions of the Institute of Electronics, Information and Communication Engineers D, Vol. J72-D2 No. 2 pp. 218-228, published on Feb. 25, 1989

$$\begin{matrix}[ Math . 1 ] & \\ c \text{?} , \hat{R} , \hat{t} = {arg min}_{c , R , t} \frac{1}{n} {\sum }_{i = 1}^{n} {‖ {Y}_{i} - ( {cRX}_{i} + t ‖}^{2} & ( 1 )\end{matrix}$$

$$\text{?} \text{indicates text missing or illegible when filed}$$

Xᵢ represents an xy coordinate value of a point of a timestamp T=i of the unknown scale, and Yᵢ represents an xy coordinate value of a point of the timestamp T=i of the real scale. c represents a scale factor indicating a scaling ratio of the footprint of the unknown scale with respect to the footprint of the real scale. R represents a rotation matrix of the footprint of the unknown scale with respect to the footprint of the real scale. t represents a parallel movement matrix of the footprint of the unknown scale with respect to the footprint of the real scale. c\hat{ }, R\hat{ }, and t\hat{ } are optimum values of c, R, and t, respectively. “c\hat{ }” is a notation of “\hat{ } (hat)” above “c” in the mathematical formula and the drawings. The same applies to other parameters.

In the example of FIG. 12, association between the footprint of the unknown scale of the group 0 and the footprint of the real scale is performed from a timestamp T0 to a timestamp T134. Further, association between the footprint of the unknown scale of the group 1 and the footprint of the real scale is performed from a timestamp T135 to a timestamp T220.

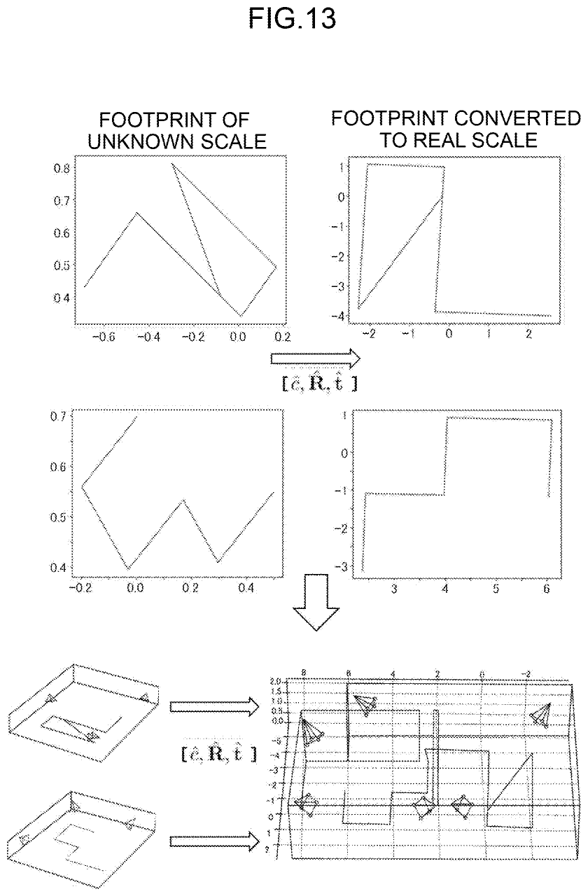

As illustrated on the upper side in FIG. 13, the third estimation unit 16 applies the calculated parameters [c\hat{ },R\hat{ },t\hat{ }] to the footprint of the unknown scale for each group and converts the footprint to the footprint of the real scale. Furthermore, as illustrated on the lower side in FIG. 13, the third estimation unit 16 converts the relative positions and the relative orientations of the plurality of fixed cameras 20 in the group into the positions and the orientations with respect to the space 30 in accordance with the conversion from the footprint of the unknown scale to the footprint of the real scale.

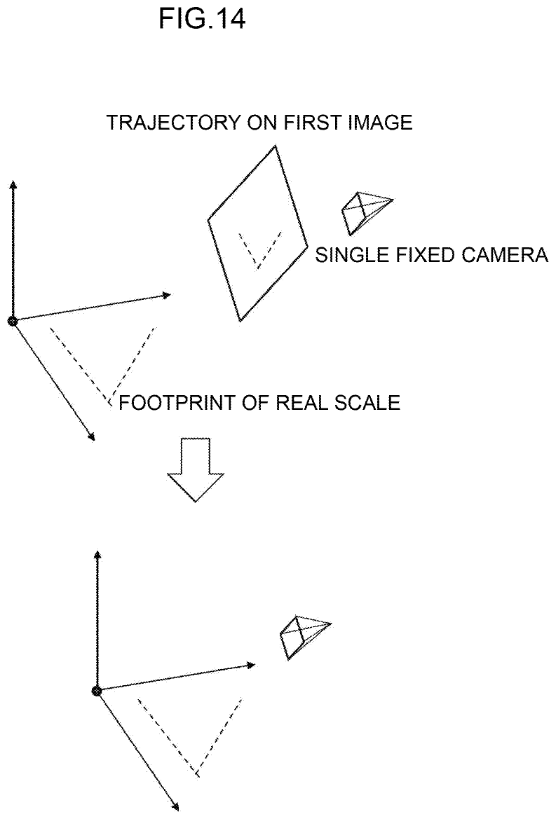

When the plurality of fixed cameras 20 are grouped, in a case where the fixed camera 20 is not classified as any group, that is, in a case where only a single fixed camera 20 is included in the group, the relative positions and the relative orientations of the fixed cameras 20 are not estimated. Therefore, the position and the orientation with respect to the space 30 cannot be estimated by the parameters calculated by Formula (1) described above. Therefore, for such a single fixed camera 20, as illustrated in FIG. 14, the third estimation unit 16 associates the footprint of the real scale in the world coordinate system estimated from the second image with the trajectory of the key point on the first image captured by the single fixed camera 20. Then, the third estimation unit 16 estimates the position and the orientation of the single fixed camera 20 in the world coordinate system, that is, the position and the orientation with respect to the space 30 based on the association.

The optimization unit 18 optimizes an estimation result of the third estimation unit 16. The estimation result of the third estimation unit 16 is the position and the orientation of each of the plurality of fixed cameras 20 with respect to the space 30, the position and the orientation being estimated based on the association between the footprint of the unknown scale and the footprint of the real scale, and the relative positions and the relative orientations of the plurality of fixed cameras 20. Furthermore, in the present embodiment, optimizing the estimation result is processing of further improving consistency of the estimation result of the third estimation unit 16 using information regarding the first image and the second image, and the like. For example, the optimization unit 18 optimizes the estimation result of the third estimation unit 16 by using a factor graph.

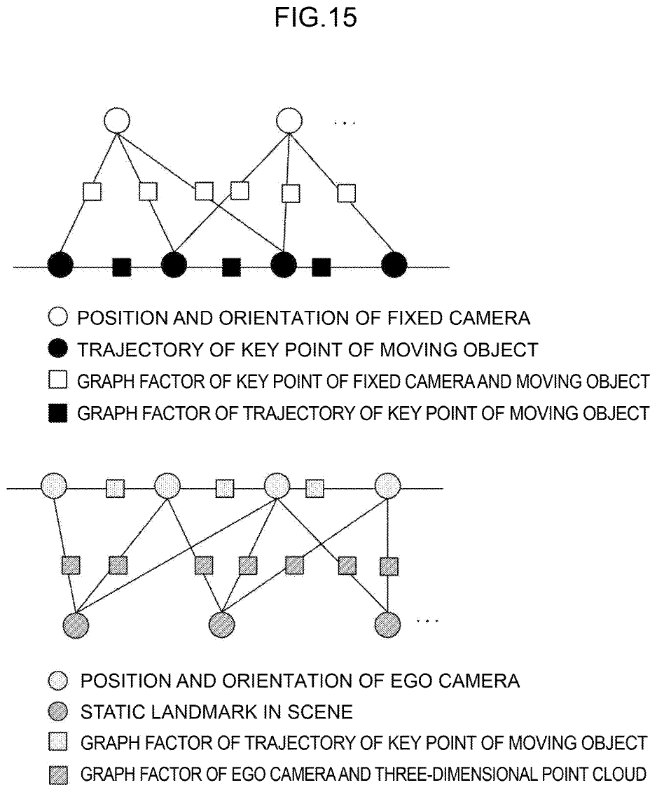

Here, for example, a factor graph in a case where the positions and the orientations of the fixed cameras are estimated in association with the key point imaged by the fixed cameras is illustrated on the upper side in FIG. 15. In the example, the factor graph is a graph including a first node representing the position and the orientation of each fixed camera and a second node representing the trajectory of the key point of the moving object (a position at each time). In addition, a graph factor of the key point of the fixed camera and the moving object is set as a constraint between the first node and the second node. In addition, a graph factor of the trajectory of the key point of the moving object is set as a constraint between the second nodes.

Furthermore, a factor graph of self-position estimation of the moving object based on the image captured by the ego camera is illustrated on, for example, the lower side in FIG. 15. In the example, the factor graph is a graph including a third node representing the position and the orientation of the ego camera at each time and a fourth node representing a static key point in a scene where the moving object moves. In addition, a graph factor of the trajectory of the key point of the moving object is set as a constraint between the third nodes, and a graph factor of the ego camera and the three-dimensional point cloud is set as a constraint between the third node and the fourth node.

On the other hand, in a factor graph of the present embodiment, the position and the orientation of each of the plurality of fixed cameras 20 with respect to the space 30, the position and the orientation of the ego camera 24, and each of landmarks in the space 30 are represented by nodes. Further, in the factor graph of the present embodiment, the footprint of the unknown scale, the footprint of the real scale, information regarding the landmarks in the space 30 obtained from the first image, and information regarding the landmarks in the space 30 obtained from the second image are set as constraints between the nodes.

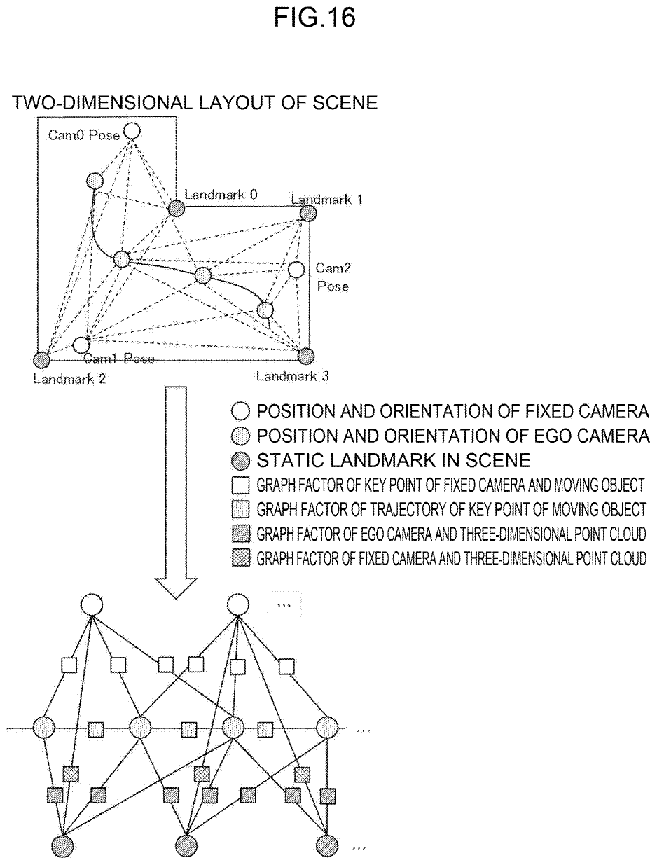

Specifically, as illustrated in FIG. 16, the factor graph of the present embodiment includes a first node representing the position and the orientation of the fixed camera 20 and a second node representing the position and the orientation of the ego camera 24 at each time. In addition, the factor graph of the present embodiment includes a third node representing the landmark in the space 30 (scene) in which the moving object 22 moves. Furthermore, a graph factor of the key point of the moving object 22 imaged by the fixed camera 20 is set as a constraint between the first node and the second node. In addition, the graph factor of the key point of the moving object 22 is set as a constraint between the second nodes. A graph factor of the three-dimensional point cloud information generated from the second image captured by the ego camera 24 is set as a constraint between the second node and the third node. A graph factor of the three-dimensional point cloud information generated from the first image captured by the fixed camera 20 and the second image captured by the ego camera 24 is set as a constraint between the first node and the third node.

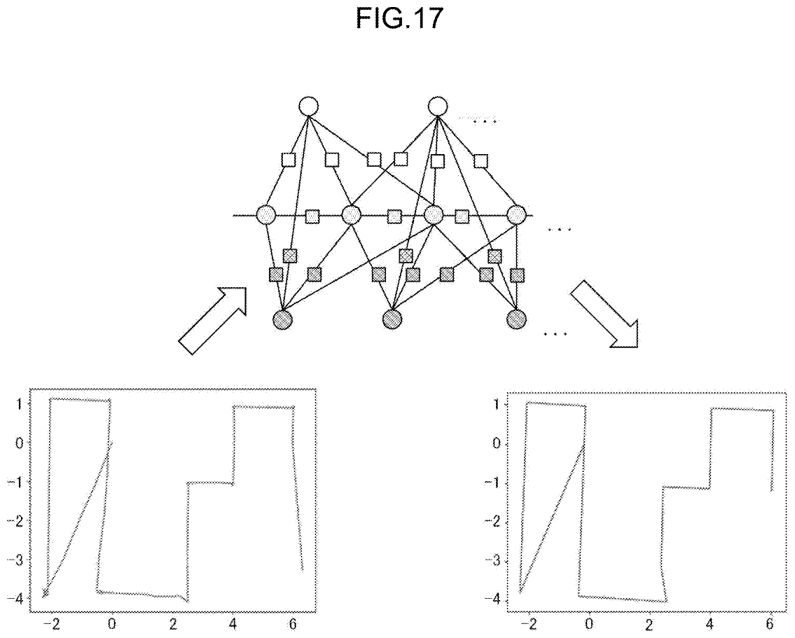

The optimization unit 18 simultaneously optimizes the position and the orientation of the fixed camera 20 with respect to the space 30 and the footprint of the real scale by using, for example, the factor graph as illustrated in FIG. 16. FIG. 17 illustrates optimization of the footprint of the real scale using the factor graph. The optimization unit 18 outputs information (hereinafter, referred to as “fixed camera position/pose information”) of the optimized position and orientation of the fixed camera 20 with respect to the space 30.

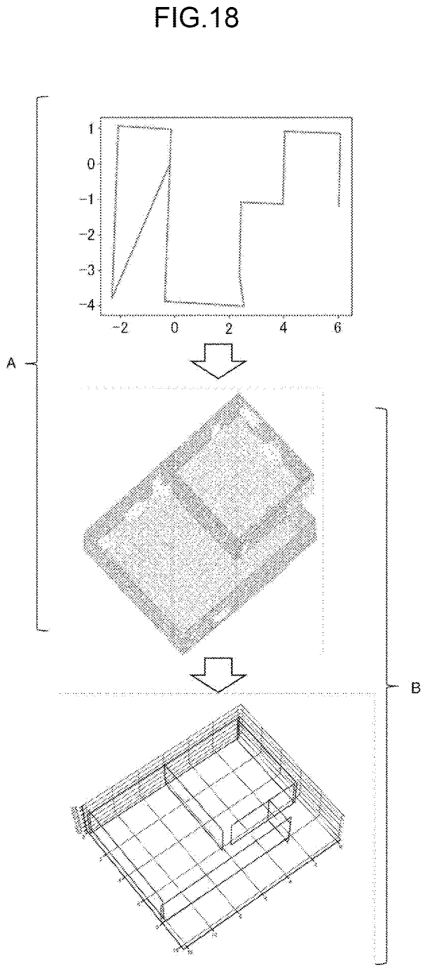

The construction unit 20 corrects the three-dimensional point cloud information of the space 30 based on the optimized estimation result, and constructs a layout map (hereinafter, referred to as “spatial three-dimensional map”) representing a three-dimensional shape of the space 30 based on the corrected three-dimensional point cloud information. Specifically, the construction unit 20 calculates a transformation matrix for conversion from the footprint of the real scale before optimization to the optimized footprint of the real scale. Then, as illustrated in A of FIG. 18, the construction unit 20 corrects the three-dimensional point cloud information by applying the calculated transformation matrix to the three-dimensional point cloud information of the space 30 estimated by the second estimation unit 14.

Furthermore, the construction unit 20 trims a portion corresponding to the floor surface from the corrected three-dimensional point cloud information by, for example, Open3D planar patch detection (http://www.open3d.org/docs/latest/tutorial/geometry/pointcloud.html#Planar-patch-detection), and detects the plane. Then, as illustrated in B of FIG. 18, the construction unit 20 constructs the spatial three-dimensional map by adding a wall surface to an outer periphery of the detected plane. The construction unit 20 outputs the constructed spatial three-dimensional map.

The output spatial three-dimensional map and the fixed camera position/pose information are registered in association with a predetermined area of a system that performs tasks such as traffic flow management, safety monitoring, and behavioral guidance of a target object such as a person or a vehicle by using the plurality of fixed cameras 20. In the system, a position of the target object can be accurately recognized from the image captured by the fixed camera 20 based on the registered information.

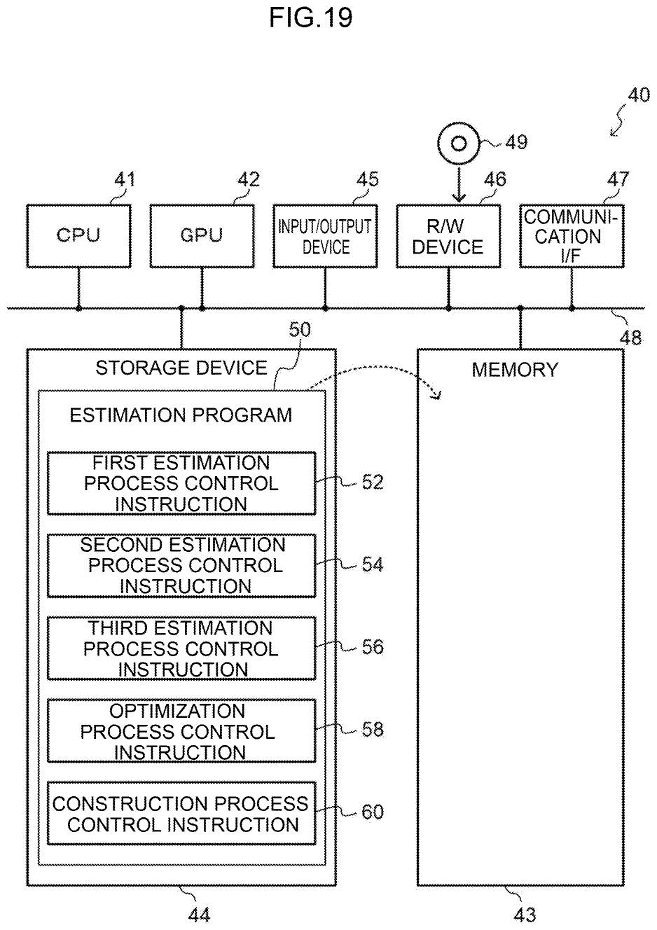

The estimation apparatus 10 may be implemented by, for example, a computer 40 illustrated in FIG. 19. The computer 40 includes a central processing unit (CPU) 41, a graphics processing unit (GPU) 42, a memory 43 serving as a temporary storage area, and a nonvolatile storage device 44. In addition, the computer 40 includes an input/output device 45 such as an input device and a display device, and a read/write (R/W) device 46 that controls reading and writing of data with respect to a storage medium 49. The computer 40 further includes a communication interface (I/F) 47 connected to a network such as the Internet. The CPU 41, the GPU 42, the memory 43, the storage device 44, the input/output device 45, the R/W device 46, and the communication I/F 47 are connected to each other via a bus 48.

The storage device 44 is, for example, a hard disk drive (HDD), a solid state drive (SSD), or a flash memory. The storage device 44 serving as a storage medium stores an estimation program 50 for causing the computer 40 to function as the estimation apparatus 10. The estimation program 50 includes a first estimation process control instruction 52, a second estimation process control instruction 54, a third estimation process control instruction 56, an optimization process control instruction 58, and a construction process control instruction 60.

The CPU 41 reads the estimation program 50 from the storage device 44, loads the program onto the memory 43, and sequentially executes the control instructions included in the estimation program 50. The CPU 41 operates as the first estimation unit 12 illustrated in FIG. 5 by executing the first estimation process control instruction 52. The CPU 41 operates as the second estimation unit 14 illustrated in FIG. 5 by executing the second estimation process control instruction 54. The CPU 41 operates as the third estimation unit 16 illustrated in FIG. 5 by executing the third estimation process control instruction 56. The CPU 41 operates as the optimization unit 18 illustrated in FIG. 5 by executing the optimization process control instruction 58. The CPU 41 operates as the construction unit 20 illustrated in FIG. 5 by executing the construction process control instruction 60. As a result, the computer 40 executing the estimation program 50 functions as the estimation apparatus 10. The CPU 41 that executes the program is hardware. Furthermore, a part of the program may be executed by the GPU 42.

The functions implemented by the estimation program 50 may be implemented by, for example, a semiconductor integrated circuit, more specifically, an application specific integrated circuit (ASIC) or a field-programmable gate array (FPGA).

Next, an operation of the estimation system 100 according to the present embodiment will be described.

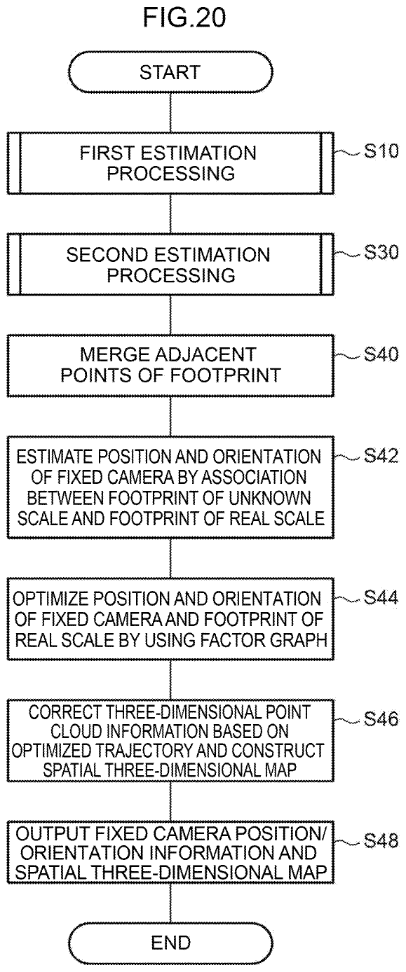

First, the moving object 22 starts moving so as to cover the entire space 30 while imaging the space 30 with the ego camera 24. At the same time, imaging by the plurality of fixed cameras 20 is also started. Then, the first image captured by each of the plurality of fixed cameras 20 during a period from the start to the end of movement of the moving object 22, and the second image including the visible light (RGB) image and the depth image captured by the ego camera 24 are input to the estimation apparatus 10. When the first image and the second image are input to the estimation apparatus 10, estimation processing illustrated in FIG. 20 is executed in the estimation apparatus 10. The estimation processing is an example of an estimation method of the disclosed technology.

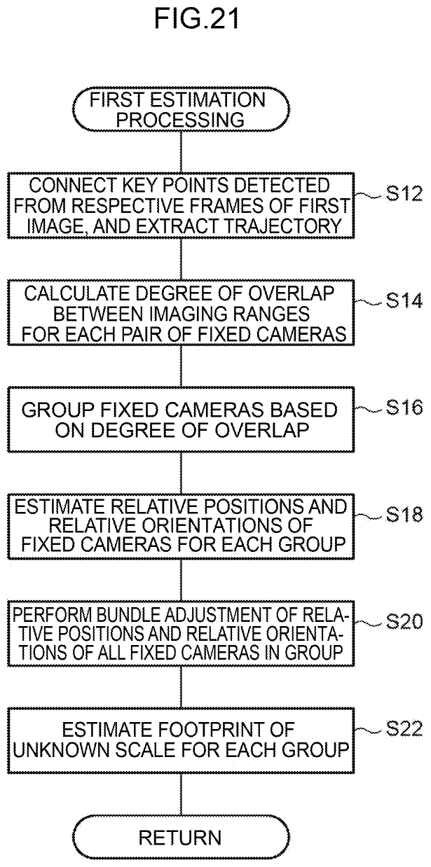

In step S10, the first estimation unit 12 executes first estimation processing. Here, the first estimation processing will be described with reference to FIG. 21.

In step S12, the first estimation unit 12 detects the key point on the moving object 22 from each frame of the first image, tracks the key point detected from each frame between the frames, and extracts the trajectory connecting the key points in the first image. Here, it is assumed that two points of the position of the top portion of the head and the foot position of the moving object 22 are detected as the key points.

Next, in step S14, the first estimation unit 12 calculates, for each pair of two fixed cameras 20 among the plurality of fixed cameras 20, a frequency at which a common key point is detected as the key point of the moving object 22 detected from each frame as the degree of overlap between the imaging ranges. Next, in step S16, the first estimation unit 12 groups the plurality of fixed cameras 20 based on the calculated degree of overlap.

Next, in step S18, the first estimation unit 12 estimates the relative positions and the relative orientations of two fixed cameras 20 included in the group based on association between the key points for the two fixed cameras 20, and three-dimensionally estimates the trajectory of the key point. Then, the first estimation unit 12 estimates the relative position and the relative orientation of another fixed camera 20 included in the group based on the first image captured by the another fixed camera 20 and the estimated three-dimensional trajectory.

Next, in step S20, the first estimation unit 12 performs bundle adjustment of the relative positions and the relative orientations of all the fixed cameras 20 included in the group. Next, in step S22, the first estimation unit 12 merges the three-dimensional trajectory based on the key point at the position of the top portion of the head of the moving object 22 estimated in step S18 with the three-dimensional trajectory based on the key point at the foot position to estimate the merged trajectory as the footprint of the unknown scale.

When the processing in steps S18 to S22 ends for each group grouped in step S16, the processing returns to the estimation processing (FIG. 20).

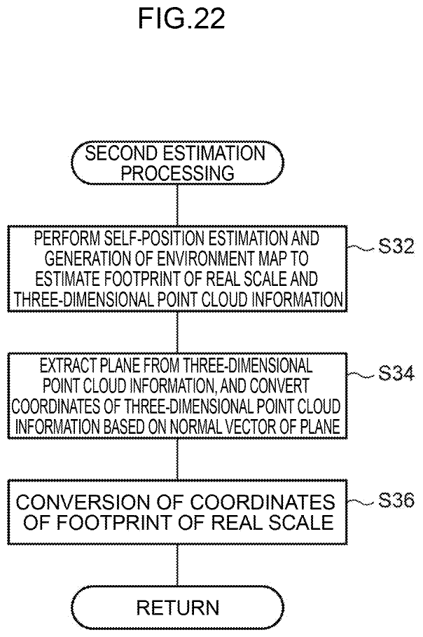

Next, in step S30, the second estimation unit 14 executes second estimation processing. Here, the second estimation processing will be described with reference to FIG. 22.

In step S32, the second estimation unit 14 simultaneously performs self-position estimation of the moving object 22 and generation of the environment map around the moving object 22 by applying SLAM, for example, based on the second image. As a result, the second estimation unit 14 estimates the footprint of the real scale of the moving object 22 to which a result of the self-position estimation at each time is connected, and estimates the three-dimensional point cloud information of the space 30.

Next, in step S34, the second estimation unit 14 extracts the plane corresponding to the floor surface of the space 30 from the three-dimensional point cloud information of the space 30, and converts the coordinates of the three-dimensional point cloud information such that the normal vector of the plane is parallel to the vertical axis of the world coordinate system. Next, in step S36, the second estimation unit 14 applies the coordinate conversion in step S34 to also convert the coordinates of the footprint of the real scale, and returns to the estimation processing (FIG. 20).

Any one of the first estimation processing in step S10 and the second estimation processing in step S30 may be executed first, or the first estimation processing in step S10 and the second estimation processing in step S30 may be executed in parallel.

Next, in step S40, the third estimation unit 16 merges a plurality of points adjacent to each other in the footprint of the real scale by associating the plurality of points with one timestamp. In addition, the third estimation unit 16 merges points in the footprint of the unknown scale, the points corresponding to the same timestamp as that of the merged point in the footprint of the real scale.

Next, in step S42, the third estimation unit 16 associates each footprint of the unknown scale of each group after merging the points with the footprint of the real scale. Then, the third estimation unit 16 calculates the parameters for converting the relative positions and the relative orientations of the fixed cameras 20 into the position and the orientation with respect to the space 30 based on the association. In addition, the third estimation unit 16 applies the calculated parameters to the footprint of the unknown scale for each group and converts the footprint to the footprint of the real scale. Then, the third estimation unit 16 estimates the position and the orientation with respect to the space 30 by converting the relative positions and the relative orientations of the plurality of fixed cameras 20 in the group in accordance with the conversion.

For a group in which only the single fixed camera 20 is included, the third estimation unit 16 associates the footprint of the real scale in the world coordinate system, which is estimated from the second image, with the trajectory of the key point on the first image captured by the single fixed camera 20. Then, the third estimation unit 16 estimates the position and the orientation of the single fixed camera 20 in the world coordinate system, that is, the position and the orientation with respect to the space 30 based on the association.

Next, in step S44, the optimization unit 18 simultaneously optimizes the position and the orientation of the fixed camera 20 with respect to the space 30 and the footprint of the real scale by using, for example, the factor graph as illustrated in FIG. 16.

Next, in step S46, the construction unit 20 calculates the transformation matrix for conversion from the footprint of the real scale before optimization to the optimized footprint of the real scale. Furthermore, the construction unit 20 corrects the three-dimensional point cloud information by applying the calculated transformation matrix to the three-dimensional point cloud information of the space 30 estimated in step S32. Then, the construction unit 20 constructs the three-dimensional map of the space 30 based on the corrected three-dimensional point cloud information.

Next, in step S48, the optimization unit 18 outputs the fixed camera position/pose information estimated in step S44, and the construction unit 20 outputs the three-dimensional map of the space 30 constructed in step S46, and ends the estimation processing.

As described above, in the estimation system according to the present embodiment, the estimation apparatus acquires the first image obtained by imaging the moving object moving in the space by each of the plurality of fixed cameras disposed in the predetermined space. The estimation apparatus estimates the footprint of the unknown scale of the moving object and the relative positions and the relative orientations of the plurality of fixed cameras based on the first image. Further, the estimation apparatus estimates the footprint of the real scale of the moving object based on the second image obtained by imaging the space from the viewpoint of the moving object while the moving object moves in the space. Then, the estimation apparatus estimates the position and the orientation of the fixed camera with respect to the space based on association between the footprint of the unknown scale and the footprint of the real scale and the relative positions and the relative orientations of the fixed cameras. As a result, it is possible to efficiently and accurately estimate the positions and the orientations of the plurality of cameras disposed in the space with respect to the space.

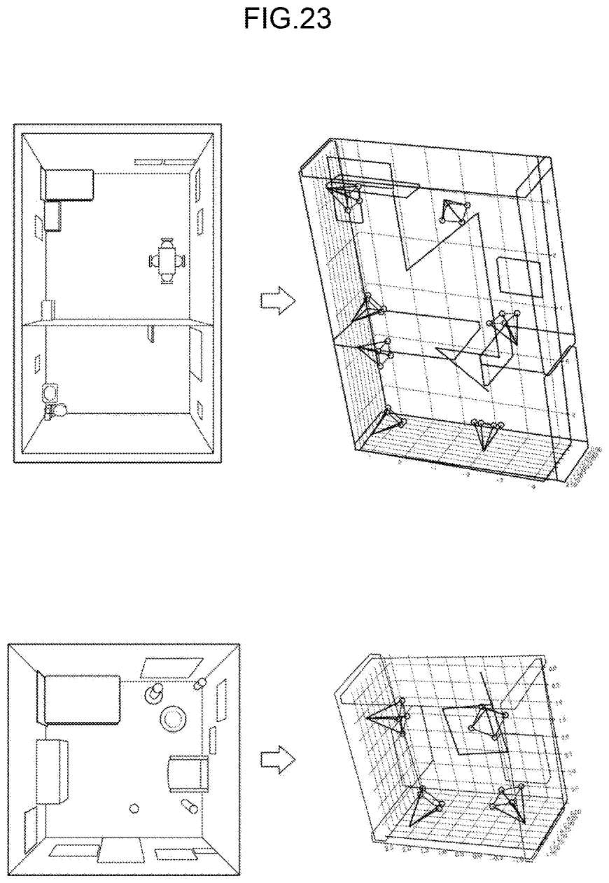

FIG. 23 schematically illustrates an example of the spatial three-dimensional map and the fixed camera position/pose information estimated by applying the present embodiment to an actual indoor scene. The fixed camera position/pose information is expressed by a quadrangular pyramid indicating the fixed camera.

In the above embodiment, a case where the visible light image and the depth image are acquired as the second image captured by the ego camera has been described, but the second image is not limited thereto. It is sufficient if information necessary for the self-position estimation of the moving object and generation of the environment map is acquired. For example, instead of the depth image, or in addition to the visible light image and the depth image, information of an inertial measurement unit (IMU) sensor may be acquired.

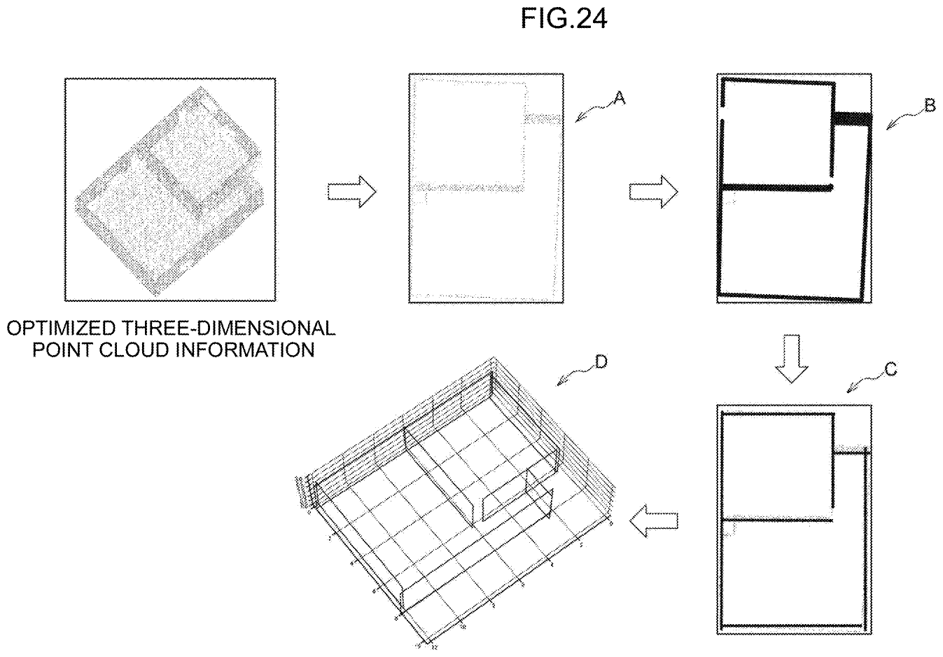

Furthermore, a method of constructing the spatial three-dimensional map in the above embodiment is an example, and the spatial three-dimensional map may be constructed by another method. For example, a method as illustrated in FIG. 24 may be applied. In the method, as illustrated in A of FIG. 24, the construction unit extracts the plane corresponding to the floor surface from the optimized three-dimensional point cloud information, and projects the three-dimensional point cloud information on the plane. Furthermore, the construction unit extracts line segments by Hough transform from the projected point cloud as illustrated in B of FIG. 24, and merges shapes of the line segments to specify a position of the wall as illustrated in C of FIG. 24. Then, as illustrated in D of FIG. 24, the construction unit constructs the spatial three-dimensional map by adding the wall to the specified position.

In the above embodiment, the estimation program is stored (installed) in the storage device in advance, but the disclosed technology is not limited thereto. The program according to the disclosed technology may be provided in a form of being stored in a storage medium such as a CD-ROM, a DVD-ROM, or a USB memory.

However, in a method of setting the external parameter of the camera based on the trajectory of the moving object, a relative external parameter between the cameras is calculated. Therefore, there is a problem in that the position and the orientation of the camera with respect to the space to which the camera is attached cannot be accurately estimated.

In addition, a method in which calibration is performed based on the association between the dropped points in the scene layout and the fields of view of the cameras is inefficient, and a possibility of causing a human error increases. In particular, in a case where the number of cameras disposed in the space is large, such a problem becomes significant.

As one aspect, an effect that it is possible to efficiently and accurately estimate positions and orientations of a plurality of cameras disposed in a space with respect to the space can be obtained.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

### REFERENCE SIGNS LIST

10 Estimation apparatus
12 First estimation unit
14 Second estimation unit
16 Third estimation unit
18 Optimization unit
20 Construction unit
20 Fixed camera
22 Moving object
24 Ego camera
30 Space
40 Computer
41 CPU
42 GPU
43 Memory
44 Storage device
45 Input/output device
46 R/W device
47 Communication I/F
48 Bus
49 Storage medium
50 Estimation program
52 First estimation process control instruction
54 Second estimation process control instruction
56 Third estimation process control instruction
58 Optimization process control instruction
60 Construction process control instruction
100 Estimation system

1. A non-transitory recording medium storing a program that causes a computer to execute estimation processing comprising:
estimating a first trajectory of a moving object and relative positions and relative orientations of a plurality of cameras disposed in a predetermined space, based on a first image obtained by imaging the moving object moving in the space by each of the plurality of cameras;
estimating a second trajectory of the moving object based on a second image obtained by imaging the space from a viewpoint of the moving object while the moving object moves in the space; and
estimating a position and an orientation of each of the plurality of cameras with respect to the space, based on association between the first trajectory and the second trajectory, and the relative positions and the relative orientations.

2. The non-transitory recording medium of claim 1, wherein an estimation result of the position and the orientation of each of the plurality of cameras with respect to the space is optimized, the position and the orientation being estimated based on the association between the first trajectory and the second trajectory and the relative positions and the relative orientations.

3. The non-transitory recording medium of claim 2, wherein the estimation result is optimized using a factor graph in which the position and the orientation of each of the plurality of cameras with respect to the space, a position and an orientation of a camera that has captured the second image, and each of landmarks in the space are represented by nodes, and the first trajectory, the second trajectory, information regarding a landmark in the space obtained from the first image, and information regarding a landmark in the space obtained from the second image are set as constraints between the nodes.

4. The non-transitory recording medium of claim 3, wherein:
the second image includes a visible light image and a depth image,
the second trajectory of the moving object is estimated, and three-dimensional point cloud information of the space is estimated, by performing, based on the second image, self-position estimation of the moving object and generation of an environment map around the moving object,
the three-dimensional point cloud information of the space is corrected based on the optimized estimation result, and
a three-dimensional map of the space is constructed based on the corrected three-dimensional point cloud information of the space.

5. The non-transitory recording medium of claim 1, wherein:
the plurality of cameras are grouped based on a degree of overlap between imaging ranges of the plurality of cameras, and
the first trajectory of the moving object and the relative positions and the relative orientations of the plurality of cameras are estimated for each group.

6. The non-transitory recording medium of claim 5, wherein, for each pair of two cameras among the plurality of cameras, a frequency at which a common key point is detected as a key point of the moving object detected from the first image at each time is calculated as the degree of overlap between the imaging ranges.

7. The non-transitory recording medium of claim 6, wherein, for two cameras included in the group, the relative positions and the relative orientations of the two cameras are estimated based on the common key point detected from the first image, the first trajectory is estimated in three dimensions, a relative position and a relative orientation of another camera other than the two cameras included in the group are estimated based on the first image captured by the other camera and the three-dimensional first trajectory, and the relative positions and the relative orientations of all the cameras included in the group are adjusted to estimate the relative positions and the relative orientations of the plurality of cameras for each group.

8. The non-transitory recording medium of claim 4, wherein a plane corresponding to a floor surface of the space is extracted from the three-dimensional point cloud information of the space, coordinates of the three-dimensional point cloud information of the space are converted such that a normal vector of the plane is parallel to a vertical axis of a world coordinate system, and coordinates of the second trajectory are converted in accordance with the converted coordinates.

9. The non-transitory recording medium of claim 1, wherein:
the first trajectory is a series of key points of the moving object detected from the first image captured at each time,
the second trajectory is a series of self-positions of the moving object at each time estimated based on the second image,
a plurality of self-positions estimated at respective consecutive times are merged into one time in a case in which the plurality of self-positions are included in a predetermined range in the second trajectory, and
key points corresponding to the respective consecutive times are merged in the first trajectory.

10. The non-transitory recording medium of claim 5, wherein, in a case in which there is one camera included in the group, a position and an orientation of the one camera with respect to the space are estimated based on association between the first trajectory corresponding to the one camera and the second trajectory in three dimensions.

11. An estimation method, comprising:
by a processor,
estimating a first trajectory of a moving object and relative positions and relative orientations of a plurality of cameras disposed in a predetermined space, based on a first image obtained by imaging the moving object moving in the space by each of the plurality of cameras;
estimating a second trajectory of the moving object based on a second image obtained by imaging the space from a viewpoint of the moving object while the moving object moves in the space; and
estimating a position and an orientation of each of the plurality of cameras with respect to the space, based on association between the first trajectory and the second trajectory, and the relative positions and the relative orientations.

12. The estimation method of claim 11, wherein an estimation result of the position and the orientation of each of the plurality of cameras with respect to the space is optimized, the position and the orientation being estimated based on the association between the first trajectory and the second trajectory and the relative positions and the relative orientations.

13. The estimation method of claim 12, wherein the estimation result is optimized using a factor graph in which the position and the orientation of each of the plurality of cameras with respect to the space, a position and an orientation of a camera that has captured the second image, and each of landmarks in the space are represented by nodes, and the first trajectory, the second trajectory, information regarding a landmark in the space obtained from the first image, and information regarding a landmark in the space obtained from the second image are set as constraints between the nodes.

14. The estimation method of claim 13, wherein:
the second image includes a visible light image and a depth image,
the second trajectory of the moving object is estimated, and three-dimensional point cloud information of the space is estimated, by performing, based on the second image, self-position estimation of the moving object and generation of an environment map around the moving object,
the three-dimensional point cloud information of the space is corrected based on the optimized estimation result, and
a three-dimensional map of the space is constructed based on the corrected three-dimensional point cloud information of the space.

15. The estimation method of claim 11, wherein:
the plurality of cameras are grouped based on a degree of overlap between imaging ranges of the plurality of cameras, and
the first trajectory of the moving object and the relative positions and the relative orientations of the plurality of cameras are estimated for each group.

16. The estimation method of claim 15, wherein, for each pair of two cameras among the plurality of cameras, a frequency at which a common key point is detected as a key point of the moving object detected from the first image at each time is calculated as the degree of overlap between the imaging ranges.

17. The estimation method of claim 16, wherein, for two cameras included in the group, the relative positions and the relative orientations of the two cameras are estimated based on the common key point detected from the first image, the first trajectory is estimated in three dimensions, a relative position and a relative orientation of another camera other than the two cameras included in the group are estimated based on the first image captured by the other camera and the three-dimensional first trajectory, and the relative positions and the relative orientations of all the cameras included in the group are adjusted to estimate the relative positions and the relative orientations of the plurality of cameras for each group.

18. The estimation method of claim 14, wherein a plane corresponding to a floor surface of the space is extracted from the three-dimensional point cloud information of the space, coordinates of the three-dimensional point cloud information of the space are converted such that a normal vector of the plane is parallel to a vertical axis of a world coordinate system, and coordinates of the second trajectory are converted in accordance with the converted coordinates.

19. The estimation method of claim 11, wherein:
the first trajectory is a series of key points of the moving object detected from the first image captured at each time,
the second trajectory is a series of self-positions of the moving object at each time estimated based on the second image,
a plurality of self-positions estimated at respective consecutive times are merged into one time in a case in which the plurality of self-positions are included in a predetermined range in the second trajectory, and
key points corresponding to the respective consecutive times are merged in the first trajectory.

20. An estimation apparatus, comprising:
a memory; and
a processor coupled to the memory, the processor being configured to execute processing, the processing including:
estimating a first trajectory of a moving object and relative positions and relative orientations of a plurality of cameras disposed in a predetermined space, based on a first image obtained by imaging the moving object moving in the space by each of the plurality of cameras;
estimating a second trajectory of the moving object based on a second image obtained by imaging the space from a viewpoint of the moving object while the moving object moves in the space; and
estimating a position and a an orientation of each of the plurality of cameras with respect to the space, based on association between the first trajectory and the second trajectory, and the relative positions and the relative orientations.
